(19) United States
(12) Patent Application Publication
(10) Pub. No.: US 2025/0039469 A1
(43) Pub. Date: Jan. 30, 2025

(54) ENHANCED PERFORMANCE AND EFFICIENCY OF VERSATILE VIDEO CODING DECODER PIPELINE FOR ADVANCED VIDEO CODING FEATURES

(71) Applicant: Intel Corporation, Santa Clara, CA (US)

(72) Inventors: Amin NURUDDIN, Folsom, CA (US); Hiu-Fai CHAN, Rancho Cordova, CA (US)

(73) Assignee: Intel Corporation, Santa Clara, CA (US)

(21) Appl. No.: 18/358,003

(22) Filed: Jul. 24, 2023

(51) Int. Cl. H04N 19/96; H04N 19/169; H04N 19/176; H04N 19/186; H04N 19/80

(52) U.S. Cl. CPC H04N 19/96; H04N 19/176; H04N 19/186; H04N 19/1883; H04N 19/80

(57) ABSTRACT

This disclosure describes systems, methods, and devices related to enhanced video coding. A device may receive encoded bitstream data of a frame with multiple tiles. The device may divide each tile into multiple coding tree units (CTUs). The device may decode Luma and Chroma pixels of each CTU using either a single-tree mode or a dual-tree mode. The device may execute a cross-component linear model (CCLM) prediction to predict Chroma pixels based on decoded Luma pixels. The device may store the decoded Luma pixels and the predicted Chroma pixels in a storage.

### TECHNICAL FIELD

This disclosure generally relates to systems and methods for video coding and, more particularly, to enhanced performance and efficiency of versatile video coding (VVC) decoder pipeline for advanced video coding features.

### BACKGROUND

Video coding can be a lossy process that sometimes results in reduced quality when compared to the original source video. Video coding standards are being developed to improve video quality.

### BRIEF DESCRIPTION OF THE DRAWINGS

FIG. 1 depicts an example system illustrating components of encoding and decoding devices, in accordance with one or more example embodiments of the present disclosure.

FIGS. 2-5 depict illustrative schematic diagrams for enhanced video coding, in accordance with one or more example embodiments of the present disclosure.

FIG. 6 illustrates a flow diagram of a process for an illustrative enhanced video coding system, in accordance with one or more example embodiments of the present disclosure.

FIG. 7 is a block diagram illustrating an example of a computing device or computing system upon which any of one or more techniques (e.g., methods) may be performed, in accordance with one or more example embodiments of the present disclosure.

Certain implementations will now be described more fully below with reference to the accompanying drawings, in which various implementations and/or aspects are shown. However, various aspects may be implemented in many different forms and should not be construed as limited to the implementations set forth herein; rather, these implementations are provided so that this disclosure will be thorough and complete, and will fully convey the scope of the disclosure to those skilled in the art. Like numbers in the figures refer to like elements throughout. Hence, if a feature is used across several drawings, the number used to identify the feature in the drawing where the feature first appeared will be used in later drawings.

### DETAILED DESCRIPTION

The following description and the drawings sufficiently illustrate specific embodiments to enable those skilled in the art to practice them. Other embodiments may incorporate structural, logical, electrical, process, algorithm, and other changes. Portions and features of some embodiments may be included in, or substituted for, those of other embodiments. Embodiments set forth in the claims encompass all available equivalents of those claims.

Luma and chroma are two primary components used in video and image processing to represent color in digital formats. luma represents the brightness or the light intensity in an image. It corresponds to the black-and-white portion of an image or video, also known as the grayscale component. It's significant because eyes are more sensitive to variations in brightness than to variations in color. In video coding, it's common to prioritize luma information to leverage this aspect of human visual perception. chroma, on the other hand, is responsible for the color information in an image or video. It captures the hue and saturation, providing the color component that, when combined with luma, gives a full-color image or video. chroma is typically represented in two parts: Cb (blue-difference) and Cr (red-difference), which contain the color differences from a reference white point. In the context of video compression, luma and chroma are often processed differently to optimize the perceived image quality versus the amount of data required to represent the video. The difference in sensitivity of the human eye to brightness and color is exploited in a process called chroma subsampling, where the resolution of the chroma information is reduced relative to the luma information. This technique can significantly reduce the amount of data needed to represent a video while having minimal impact on perceived image quality.

Cross Component Linear Model (CCLM) is a type of intra-prediction used in the Versatile Video Coding (VVC) standard. It's a technique specifically designed to improve the efficiency of chroma prediction, which is the prediction of color components in a video frame.

Traditional chroma intra-prediction methods predict chroma blocks directly from previously reconstructed chroma blocks. However, in the CCLM approach, chroma blocks are predicted using a linear combination of previously reconstructed luma and chroma samples.

CCLM intra-prediction in VVC dual tree mode requires a very efficient storage scheme for corresponding luma reconstruction (“recon”) pixels and neighbor luma recon pixels for the current chroma block or CTU to meet the decoder performance goals with the previous generation of codecs. Reuse of some down-sampled luma recon storage for CCLM single tree mode reduces the area of storage by almost half for this feature and meets performance goals at the same time.

VVC requires an extra pass of PDPC filtering after a traditional intra-prediction process for certain block sizes. It makes design harder to meet performance for smaller blocks when it is already tight. Parallel computation of some of the PDPC filtering algorithms with intra-prediction computation made it possible to achieve performance criteria for smaller and helped accomplish overall decoder pipe performance metrics.

Multi luma Reference recon neighbor storage is reused for intra-prediction in CIIP mode for block level neighbor recon storage when the coding block size is different from the transform size helped to save a significant amount of area for this feature.

Inter-prediction data requires LMCS mapping for CIIP mode and when slice level LMCS mapping is enabled. Mapping for both modes is optimized by reusing logic. Also, LMCS parameters decoding used for Inter LMCS mapping is reused by residual chroma scaling to simplify decode pipe design implementation. Logic placement of these two LMCS features also helped to achieve validation gain when validating against VVC C-model implementation.

This is the first generation of the above features development. There are no previous solutions available for reference.

Example embodiments of the present disclosure relate to systems, methods, and devices for VVC Decoder pipe performance and area efficiency for CCLM intra-prediction, CIIP prediction, PDPC filtering, and Inter-prediction luma mapping and residual chroma scaling features.

In one or more embodiments, an enhanced video coding system may leverage the reuse of existing features in the design for single tree CCLM storage, which contributes to the reduction in area and enhancement in performance for CCLM in VVC dual tree mode. For instance, an existing video codec architecture could be modified to adopt these features, thereby improving its efficiency, and reducing the area it occupies. In these embodiments, the parallel calculation of Prediction with Partially Decorrelated and post-processed chroma (PDPC) filtering logic substantially aids in meeting System Definition (SD) requirements and attaining a performance that is comparable for Intra frames with preceding codec generations.

In one or more embodiments, an enhanced video coding system may exploit the existing storage of Multi luma Reference luma recon neighbors, which assists in saving approximately 30K-35K gates for Combined Inter Intra-prediction (CIIP) neighbors' storage. For example, a digital video broadcasting system could implement this storage approach to save gates and enhance overall efficiency. In these embodiments, certain common luma Mapping with chroma Scaling (LMCS) parameters may be reused between Inter-prediction and residual LMCS mapping. This reuse contributes to area saving, design simplicity, and cases the validation against VVC C-model LMCS algorithms.

In one or more embodiments, an enhanced video coding system may consider the importance of Intra frame performance in the decoder pipe. For example, in a high-definition video streaming application, ensuring robust Intra frame performance can lead to improved streaming quality and user experience. The system understands that VVC codec decode algorithms for Intra blocks are substantially more complex than those of previous codec generations. Therefore, it necessitates a significant amount of parallel computation and reuse of logic to meet overall performance metrics, whilst keeping the design area minimal. In these embodiments, all the above-mentioned features are optimized to furnish a performance-efficient design for future-generation products.

The above descriptions are for purposes of illustration and are not meant to be limiting. Numerous other examples, configurations, processes, algorithms, etc., may exist, some of which are described in greater detail below. Example embodiments will now be described with reference to the accompanying figures.

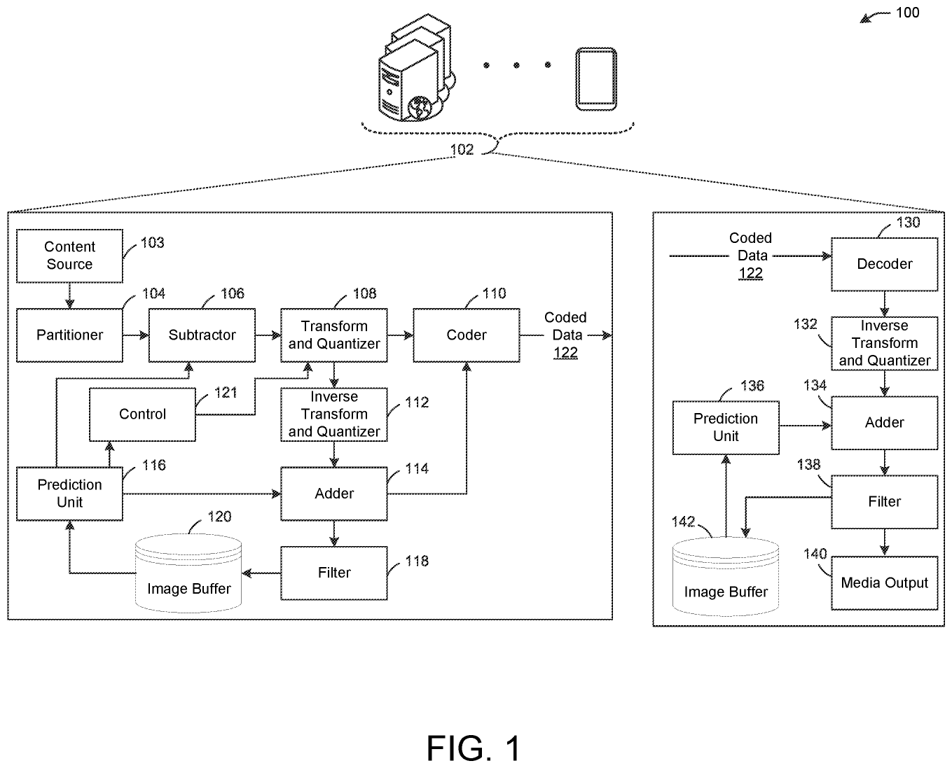

FIG. 1 depicts an example system 100 illustrating components of encoding and decoding devices, according to some example embodiments of the present disclosure.

Referring to FIG. 1, the system 100 may include devices 102 having encoder and/or decoder components. As shown, the devices 102 may include a content source 103 that provides video and/or audio content (e.g., a camera or other image capture device, stored images/video, etc.). The content source 103 may provide media (e.g., video and/or audio) to a partitioner 104, which may prepare frames of the content for encoding. A subtractor 106 may generate a residual as explained further herein. A transform and quantizer 108 may generate and quantize transform units to facilitate encoding by a coder 110 (e.g., entropy coder). Transform and quantized data may be inversely transformed and inversely quantized by an inverse transform and quantizer 112. An adder 114 may compare the inversely transformed and inversely quantized data to a prediction block generated by a prediction unit 116, resulting in reconstructed frames. A filter 118 (e.g., in-loop filter for resizing/cropping, color conversion, de-interlacing, composition/blending, etc.) may revise the reconstructed frames from the adder 114, and may store the reconstructed frames in an image buffer 120 for use by the prediction unit 116. A control 121 may manage many encoding aspects (e.g., parameters) including at least the setting of a quantization parameter (QP) but could also include setting bitrate, rate distortion or scene characteristics, prediction and/or transform partition or block sizes, available prediction mode types, and best mode selection parameters, for example, based at least partly on data from the prediction unit 116. Using the encoding aspects, the transform and quantizer 108 may generate and quantize transform units to facilitate encoding by the coder 110, which may generate coded data 122 that may be transmitted (e.g., an encoded bitstream).

Still referring to FIG. 1, the devices 102 may receive coded data (e.g., the coded data 122) in a bitstream, and a decoder 130 may decode the coded data, extracting quantized residual coefficients and context data. An inverse transform and quantizer 132 may reconstruct pixel data based on the quantized residual coefficients and context data. An adder 134 may add the residual pixel data to a predicted block generated by a prediction unit 136. A filter 138 may filter the resulting data from the adder 134. The filtered data may be output by a media output 140, and also may be stored as reconstructed frames in an image buffer 142 for use by the prediction unit 136.

Referring to FIG. 1, the system 100 performs the methods of intra-prediction disclosed herein, and is arranged to perform at least one or more of the implementations described herein including intra block copying. In various implementations, the system 100 may be configured to undertake video coding and/or implement video codecs according to one or more standards. Further, in various forms, video coding system 100 may be implemented as part of an image processor, video processor, and/or media processor and undertakes inter-prediction, intra-prediction, predictive coding, and residual prediction. In various implementations, system 500 may undertake video compression and decompression and/or implement video codecs according to one or more standards or specifications, such as, for example, H.264 (Advanced Video Coding, or AVC), VP8, H.265 (High Efficiency Video Coding or HEVC) and SCC extensions thereof, VP9, Alliance Open Media Version 1 (AV1), H.266 (Versatile Video Coding. or VVC), DASH (Dynamic Adaptive Streaming over HTTP), and others. Although system 100 and/or other systems, schemes or processes may be described herein, the present disclosure is not necessarily always limited to any particular video coding standard or specification or extensions thereof.

As used herein, the term “coder” may refer to an encoder and/or a decoder. Similarly, as used herein, the term “coding” may refer to encoding via an encoder and/or decoding via a decoder. A coder, encoder, or decoder may have components of both an encoder and decoder. An encoder may have a decoder loop as described below.

For example, the system 100 may be an encoder where current video information in the form of data related to a sequence of video frames may be received to be compressed. By one form, a video sequence (e.g., from the content source 103) is formed of input frames of synthetic screen content such as from, or for, business applications such as word processors, power points, or spread sheets, computers, video games, virtual reality images, and so forth. By other forms, the images may be formed of a combination of synthetic screen content and natural camera captured images. By yet another form, the video sequence only may be natural camera captured video. The partitioner 104 may partition each frame into smaller more manageable units, and then compare the frames to compute a prediction. If a difference or residual is determined between an original block and prediction, that resulting residual is transformed and quantized, and then entropy encoded and transmitted in a bitstream, along with reconstructed frames, out to decoders or storage. To perform these operations, the system 100 may receive an input frame from the content source 103. The input frames may be frames sufficiently pre-processed for encoding.

The system 100 also may manage many encoding aspects including at least the setting of a quantization parameter (QP) but could also include setting bitrate, rate distortion or scene characteristics, prediction and/or transform partition or block sizes, available prediction mode types, and best mode selection parameters to name a few examples.

The output of the transform and quantizer 308 may be provided to the inverse transform and quantizer 112 to generate the same reference or reconstructed blocks, frames, or other units as would be generated at a decoder such as decoder 130. Thus, the prediction unit 116 may use the inverse transform and quantizer 112, adder 114, and filter 118 to reconstruct the frames.

The prediction unit 116 may perform inter-prediction including motion estimation and motion compensation, intra-prediction according to the description herein, and/or a combined inter-intra-prediction. The prediction unit 116 may select the best prediction mode (including intra-modes) for a particular block, typically based on bit-cost and other factors. The prediction unit 116 may select an intra-prediction and/or inter-prediction mode when multiple such modes of each may be available. The prediction output of the prediction unit 116 in the form of a prediction block may be provided both to the subtractor 106 to generate a residual, and in the decoding loop to the adder 114 to add the prediction to the reconstructed residual from the inverse transform to reconstruct a frame.

The partitioner 104 or other initial units not shown may place frames in order for encoding and assign classifications to the frames, such as I-frame, B-frame, P-frame and so forth, where I-frames are intra-predicted. Otherwise, frames may be divided into slices (such as an I-slice) where each slice may be predicted differently. Thus, for HEVC or AV1 coding of an entire I-frame or I-slice, spatial or intra-prediction is used, and in one form, only from data in the frame itself.

In various implementations, the prediction unit 116 may perform an intra block copy (IBC) prediction mode and a non-IBC mode operates any other available intra-prediction mode such as neighbor horizontal, diagonal, or direct coding (DC) prediction mode, palette mode, directional or angle modes, and any other available intra-prediction mode. Other video coding standards, such as HEVC or VP9 may have different sub-block dimensions but still may use the IBC search disclosed herein. It should be noted, however, that the foregoing are only example partition sizes and shapes, the present disclosure not being limited to any particular partition and partition shapes and/or sizes unless such a limit is mentioned or the context suggests such a limit, such as with the optional maximum efficiency size as mentioned. It should be noted that multiple alternative partitions may be provided as prediction candidates for the same image area as described below.

The prediction unit 116 may select previously decoded reference blocks. Then comparisons may be performed to determine if any of the reference blocks match a current block being reconstructed. This may involve hash matching. SAD search, or other comparison of image data, and so forth. Once a match is found with a reference block, the prediction unit 116 may use the image data of the one or more matching reference blocks to select a prediction mode. By one form, previously reconstructed image data of the reference block is provided as the prediction, but alternatively, the original pixel image data of the reference block could be provided as the prediction instead. Either choice may be used regardless of the type of image data that was used to match the blocks.

The predicted block then may be subtracted at subtractor 106 from the current block of original image data, and the resulting residual may be partitioned into one or more transform blocks (TUs) so that the transform and quantizer 108 can transform the divided residual data into transform coefficients using discrete cosine transform (DCT) for example. Using the quantization parameter (QP) set by the system 100, the transform and quantizer 108 then uses lossy resampling or quantization on the coefficients. The frames and residuals along with supporting or context data block size and intra displacement vectors and so forth may be entropy encoded by the coder 110 and transmitted to decoders.

In one or more embodiments, a system 100 may have, or may be, a decoder, and may receive coded video data in the form of a bitstream and that has the image data (chroma and luma pixel values) and as well as context data including residuals in the form of quantized transform coefficients and the identity of reference blocks including at least the size of the reference blocks, for example. The context also may include prediction modes for individual blocks, other partitions such as slices, inter-prediction motion vectors, partitions, quantization parameters, filter information, and so forth. The system 100 may process the bitstream with an entropy decoder 130 to extract the quantized residual coefficients as well as the context data. The system 100 then may use the inverse transform and quantizer 132 to reconstruct the residual pixel data.

The system 100 then may use an adder 134 (along with assemblers not shown) to add the residual to a predicted block. The system 100 also may decode the resulting data using a decoding technique employed depending on the coding mode indicated in syntax of the bitstream, and either a first path including a prediction unit 136 or a second path that includes a filter 138. The prediction unit 136 performs intra-prediction by using reference block sizes and the intra displacement or motion vectors extracted from the bitstream, and previously established at the encoder. The prediction unit 136 may utilize reconstructed frames as well as inter-prediction motion vectors from the bitstream to reconstruct a predicted block. The prediction unit 136 may set the correct prediction mode for each block, where the prediction mode may be extracted and decompressed from the compressed bitstream.

In one or more embodiments, the coded data 122 may include both video and audio data. In this manner, the system 100 may encode and decode both audio and video.

It is understood that the above descriptions are for the purposes of illustration and are not meant to be limiting.

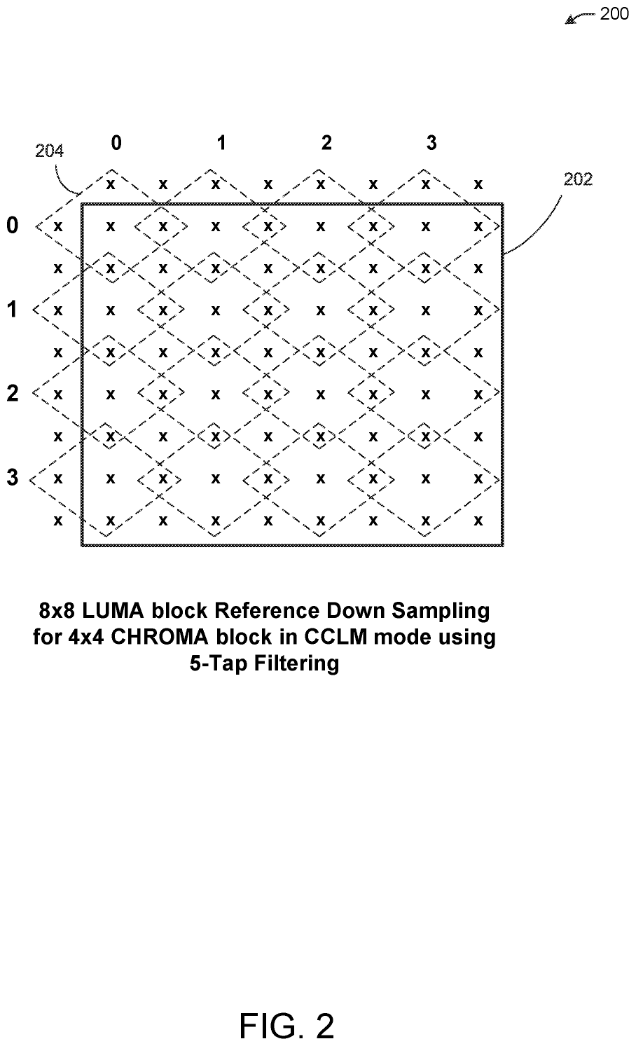

FIGS. 2-5 depict illustrative schematic diagrams for enhanced video coding, in accordance with one or more example embodiments of the present disclosure.

This disclosure proposes performance enhancement and power efficiency with a focus promotion on hardware gate count optimization. The concept refines the underlying algorithm to adapt it seamlessly for hardware utilization while ensuring that performance is not compromised. Performance, in this context, pertains to the number of cycles required to decode pixels from an encoded frame. The objective is to maintain a decoding performance that is competitive with previous generations of codecs.

In terms of area optimization, this disclosure illustrates techniques to streamline a comprehensive algorithm or feature to ensure its implementation requires a minimal gate count and transistor count. The aim is power preservation, achieved through reduced area requirements and improved operational efficiency.

Performance considers the division of operations into multiple sections, referred to as latency in hardware terminology. Latency is the measure of the number of cycles required to decode a specific feature. For example, a complex mathematical equation may require processing in multiple sections and decoded sequentially over different clock cycles. The number of cycles required depends on the complexity of the equation, thereby determining performance.

Considering that VVC is a more complex codec compared to its predecessors, performance becomes a critical factor. When referring to preceding generations, codecs such as the High Efficiency Video Coding (HEVC) and AV1, developed as a part of Open Media Alliance, are considered. Although VVC's design is substantially larger and more complex, the aim is to match, if not surpass, the performance efficiency of these earlier codecs.

In order to achieve the described performance and efficiency goals, this disclosure incorporates several features like Cross-Component Linear Model (CCLM), Context-based Adaptive Image Partitioning (CIIP), and Position-Dependent-Predicted (PDP) Coding filtering. These features are important components of the various embodiments helping to improve both performance and efficiency.

In one or more embodiments, an enhanced video coding system may facilitate a CCLM mode to increase prediction accuracy and overall efficiency in the VVC codec.

In the typical process of decoding, luma pixel values are decoded first, followed by the corresponding chroma pixel values for the same block. Usually, these two are decoded independently of each other, with luma being predicted from previously decoded luma and chroma being predicted from previously decoded chroma. There is no interconnection between the two under standard conditions.

However, in a specific mode involving CCLM, an interconnection between luma and chroma comes into play. In this mode, the prediction of chroma pixel values is dependent not on previously decoded chroma, but instead on previously decoded luma values. This unique correlation between luma and chroma in the CCLM mode fundamentally alters the prediction dynamics, potentially enhancing the prediction accuracy and thereby the overall efficiency of the decoding process in the Versatile Video Coding (VVC) codec. The key takeaway is that the CCLM mode uses luma values to predict chroma values, potentially increasing prediction accuracy and overall efficiency in the VVC codec.

CCLM is one of the intra-prediction modes for chroma blocks. It requires current chroma block neighbor recon pixels and corresponding luma block recon pixels and luma recon neighbor pixels to predict the current chroma block pixel values.

Chroma block neighbor recon pixels refer to the reconstructed pixels from neighboring blocks to a current chroma block to be used for prediction. Corresponding luma block recon pixels refers to the reconstructed pixels of a luma block that corresponds to a given chroma block. Luma recon neighbor pixels refers to the reconstructed pixels from neighboring blocks to a current luma block to be used for prediction.

The prediction samples predSamples[x][y] with x=0 . . . nTbW−1, y=0 . . . nTbH−1 are derived as follows.

$$predSamples [ x ] [ y ] = Clip 1 ( ( ( pDsY [ x ] [ y ] * a ) >> k ) + b )$$

Here, nTbW and nTbH are width and height of current chroma transform unit.

pDsY[x][y] is the down-sampled luma recon block pixels as described below.

Parameters ‘a’, ‘b’ and ‘k’ in above equation are derived from current block chroma recon neighbor and corresponding luma block neighbor recon pixels. Down-sampling of neighbor luma pixels is done same way as luma recon pixels through either 5-tap or 6-tap filtering.

The ‘a’, ‘b’, and ‘k’ parameters refer to specific variables used in CCLM prediction process for chroma (Cb and Cr) pixel values based on luma pixel values. These parameters play a crucial role in determining the relationship between the luma and chroma components during prediction.

Generally, ‘a’ represents the scale factor that is applied to the luma pixel values. ‘b’ represents the offset value that is added to the scaled luma pixel values. ‘k’ represents the bit-depth parameter, which determines the precision of the pixel values. The specific values of ‘a’, ‘b’, and ‘k’ are derived from the surrounding luma and chroma pixel values and may vary depending on the prediction mode and the encoding configuration. These parameters are used in the CCLM prediction equation to estimate the chroma pixel values from the corresponding luma pixel values.

The parameters ‘a’, ‘b’, and ‘k’ are denoted as luma neighbor reconstruction parameters, serving as important elements in the CCLM prediction process, derived specifically from corresponding luma neighbor recon pixels. An enhanced video coding system derives these parameters differently in single-tree and dual-tree configurations. Through this process, these parameters are used in conjunction with down-sampled luma recon pixels, facilitating data prediction for the CCLM. In essence, luma values are utilized in CCLM to predict the chroma values (Cb and Cr). In simpler terms, the ‘a’, ‘b’, and ‘k’ parameters are derived from luma data and are used in conjunction with down-sampled luma pixels to enhance the CCLM prediction process.

The following shows luma reference down-sampling:

Down-sampled luma reference pDsY[x][y] with x=0 . . . nTbW−1, y=0 . . . nTbH−1 are derived as follows from recon pixels as follows for 4:2:0 mode,

If sps_chroma_vertical_collocated_flag is equal to 1, down-sampling is done using 5-tap filter as below,

$$p D s Y [ x ] [ y ] = ( pY [ 2 * x ] [ 2 * y - 1 ] + pY [ 2 * x - 1 ] [ 2 * y ] + 4 * pY [ 2 * x ] [ 2 * y ] + pY [ 2 * x + 1 ] [ 2 * y ] + pY [ 2 * x ] [ 2 * y + 1 ] + 4 ) >> 3$$

(Note: pY[x][y] is previously decoded corresponding luma block pixels.)

FIG. 2 depicts an illustrative schematic diagram 200 for enhanced video coding, in accordance with one or more example embodiments of the present disclosure.

Referring to FIG. 2, there is shown an implementation of 5-tap filtering for an 8×8 luma block 202.

As can be seen in FIG. 2, in an 8×8 luma block 202, every five pixels (referenced by x) in each dotted region 204, are down sampled to 1 pixel, resulting in a 4×4 chroma block (referenced by 0, 1, 2, 3).

If sps_chroma_vertical_collocated_flag is equal to 0, down-sampling is done using 6-tap filter as below,

$$p D s Y [ x ] [ y ] = ( pY [ 2 * 1 ] [ 2 * x - 1 ] [ 2 * y ] + pY [ 2 * x - 1 ] [ 2 * y + 1 ] + 2 * pY [ 2 * x ] [ 2 * y ] + 2 * pY [ 2 * x ] [ 2 * y + 1 ] + pY [ 2 * x + 1 ] [ 2 * y ] + pY [ 2 * x + 1 ] [ 2 * y + 1 ] + 4 ) >> 3$$

The 4:2:0 mode is a color subsampling scheme commonly used in digital video formats. It represents the arrangement of chroma (color) information relative to luma (brightness) information in a compressed video stream. The “4” in 4:2:0 indicates that for every 4 luma samples (Y), there are 2 chroma samples (Cb and Cr). 4:2:0 means 2:1 horizontal downsampling, with 2:1 vertical downsampling. Vertical down sampling does not happen in 4:2:2 format. However, in the horizontal direction, the chroma samples are subsampled by a factor of 2, resulting in a reduced resolution for chroma compared to luma. In practice, this means that in a 4:2:0 video stream, the luma component is sampled at full resolution, while the chroma components are sampled at half the horizontal resolution. This chroma subsampling technique exploits the human visual system's higher sensitivity to changes in brightness compared to changes in color. It allows for a significant reduction in the amount of data required to represent the video while maintaining acceptable image quality.

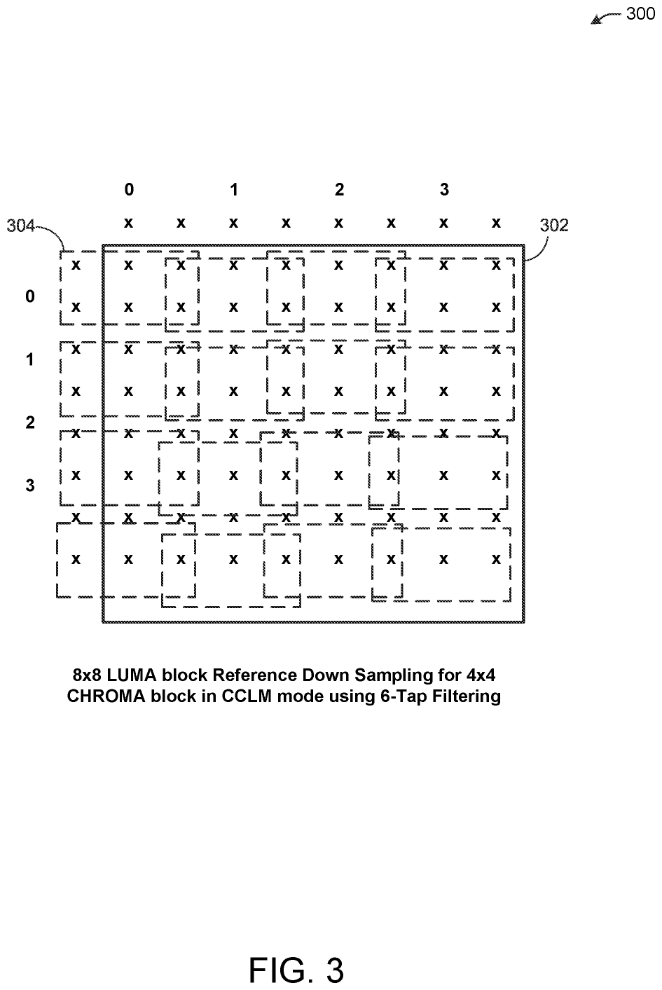

FIG. 3 depicts an illustrative schematic diagram 300 for enhanced video coding, in accordance with one or more example embodiments of the present disclosure.

Referring to FIG. 3, there are shown specific pixels utilized to obtain collocated down-sample values within an 8×8 luma block.

As can be seen in FIG. 3, in an 8×8 luma block 302, every six pixels (referenced by x) in each dotted region 304, are down sampled to 1 pixel, resulting in a 4×4 chroma block (referenced by 0, 1, 2, 3).

In VVC single tree mode, chroma blocks come after corresponding luma blocks and hence luma neighbor recon storage is immediately used when predicting chroma CCLM prediction values.

In VVC dual-tree mode, all luma blocks are decoded first before the start of the chroma blocks in CTU or 64×64 region whichever is smaller. Also, chroma block partitioning can be different than previously decoded corresponding luma pixels.

Considering an entire frame that may be partitioned into various tiles. Each tile's area is further divided into multiple square sections, called CTUs. CTUs come in two sizes, 64 by 64 blocks, and 128 by 128 blocks.

Upon receiving a bitstream, data for the initial 64 by 64 CTU is decoded first, then the next 64 by 64 CTU. This sequence continues, decoding one 64 by 64 area at a time.

Inside a 64 by 64 CTU, there can be one or several prediction blocks, decoded one by one. The decoding order, particularly for luma and chroma, changes depending on whether a single-tree or dual-tree mode is applied. In single-tree mode, the luma prediction block is decoded first, followed by the chroma for that same block. For instance, within a 64 by 64 CTU, there are four 32 by 32 blocks. In single-tree mode, the luma for the first 32 by 32 block is decoded, then its chroma. This procedure repeats for every block inside the 64 by 64 CTU.

Contrarily, in dual-tree mode, all luma pixels for all 32 by 32 blocks inside the 64 by 64 CTU are decoded first. Only after all luma data is decoded does the decoding of the respective chroma pixels start. This difference in the decoding sequence is a differentiation between single-tree and dual-tree modes.

The significance of these modes comes into play when considering algorithms like CCLM. In single-tree mode, when a block's luma is decoded, all required pixels from that block are saved. These saved pixels can be immediately used when generating chroma under CCLM mode. Thus, the chosen tree mode can notably influence the design and efficiency of codecs such as VVC.

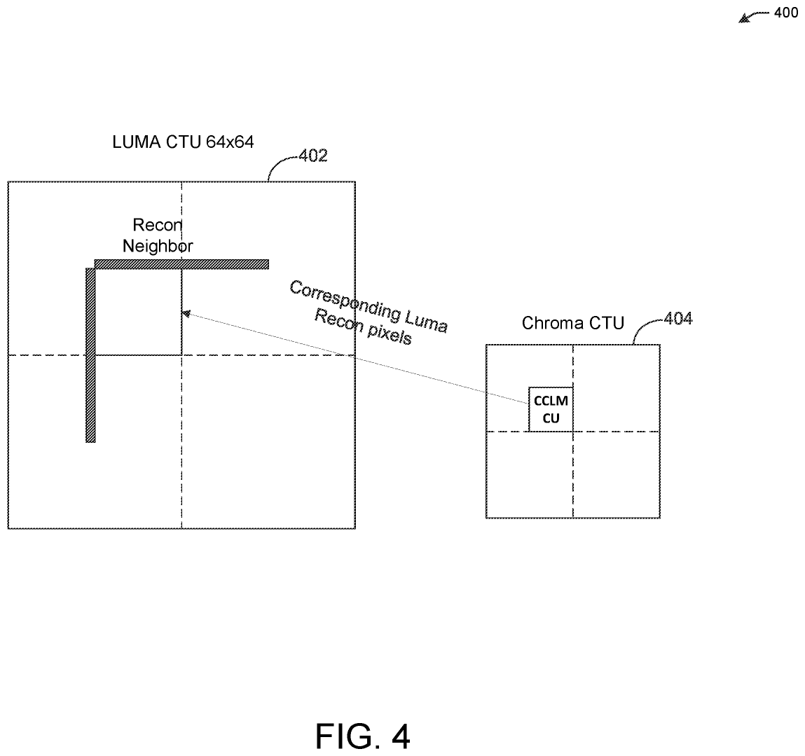

FIG. 4 depicts an illustrative schematic diagram 400 for enhanced video coding, in accordance with one or more example embodiments of the present disclosure.

The above decoding order requires special handling of luma neighbor down-sampled pixels to derive parameters ‘a’, ‘b’ and ‘k’, when chroma block positions are not at the start of the CTU or 64×64 region as shown in FIG. 4.

Since all luma pixels are decoded first and the uncertainty of chroma block start position, there are two ways to get down-sampled neighbor luma pixels required to derive CCLM parameters. In other words, the start position of the chroma (color) block within a larger image block is not always certain because the chroma blocks can be smaller and positioned in different locations within the larger block. This can complicate the process of deriving the CCLM parameters, which are used to predict the chroma values based on the luma values.

1) The first option is to store the entire 64×64 luma CTU 402 to separate storage and use them when the chroma block parameters associated with a chroma CTU 404 are received and down-sampled to derive parameters ‘a’, ‘b’, and ‘k’. The chroma block parameters refer to the data needed to decode the chroma information within the block, and to be used in conjunction with the luma neighbor reconstruction parameters (‘a’, ‘b’, and ‘k’) to aid in the CCLM prediction process. The chroma block parameters comprise a variety of information relevant to the block's encoding, positioning, and composition. This may include the block's size and location within the frame, the encoding type utilized, quantization parameters, or other parameters. Predictive coding parameters might also be included, providing a description of how the block's data can be inferred from other data within the frame. Finally, the parameters may include the color data within the block itself, represented as the two chroma components, Cr and Cb. The chroma block parameters would be received by a decoder as part of the normal process of reading the encoded video data. Once received, these parameters could then be used in conjunction with the separately stored luma data to derive the CCLM parameters ‘a’, ‘b’, and ‘k’. The chroma block parameters are down-sampled at the point in the process when the decoder is ready to associate the chroma data with the luma data to predict the chroma values using CCLM prediction. This typically happens after the luma data has been decoded and the chroma block parameters have been received by the decoder.

2) The second option is to use the current chroma block position within CTU or 64×64 region, size of the current block, and neighbor availability to get the position for required down-sampled neighbor pixels and scale that position to luma down-sampled position. In other words, scale the chroma block's position and size to match the luma's down-sampled resolution. Then use this position to read down-sampled luma neighbor block pixels from existing 32×32 down-sampled luma pixel storage. This involves locating the right pixels within the storage based on the scaled position. Each chroma block has a specific size, which is typically smaller than the CTU or 64×64 region it resides in. The size of the current block refers to the dimensions of this chroma block.

Since down-sampling logic remains the same for both corresponding luma block and neighbor luma pixels, these pixels are available in existing down-sampled storage. Current VVC hardware decoder uses the second method which adds some design complexities but saves a large area of 64×64 pixels storage described in option 1 above.

In one or more embodiments, an enhanced video coding system may facilitate enhancements to the CIIP mode.

In VVC, CIIP mode is one of the compound prediction modes where prediction data of the block is derived from the compound prediction of Inter and Intra predicted data. Intra-prediction in CIIP mode is handled at the coding block level instead of the transform level and this requires special handling of neighbor pixels when the coding block size is different than the transform size.

In one or more embodiments, an enhanced video coding system may involve decoding intra frames. Intra decoding requires neighbor pixels from the current block. Therefore, in decoding a number one block, the neighbor pixels needed are from the top section as well as the left section. These neighbor pixels are crucial for generating intra data. In this mode, the Luma CU is 64 by 64 in size, as specified in the standard. The prediction block unit size is also 64 by 64, and there is a Transform unit. Transform unit can exceed 32×32 if maxTbSize Y is 64 (>32). It cannot exceed if maxTbSizeY is 32. Thus, the 64 by 64 prediction unit is divided into four 32 by 32 blocks. Encoding involves two block sizes: prediction block size and transform block size. If the prediction block size is larger than the transform block size, it must be divided into multiple blocks.

For instance, if the transform block size is 64 by 64 and the prediction block size is 64 by 64, the 64 by 64 block will be predicted as a single block. The neighbor pixels used in this case are the top immediate 129 pixels and the left immediate 128 pixels. However, when the transform size becomes 32 by 32, the prediction block size also becomes 32 by 32 internally. Consequently, the neighbor pixels for each block will differ, such as when transitioning from the first block to the fourth block. The neighbors will be sourced from different locations, following the standard's specifications.

In terms of storage, there is a separate storage mechanism for nearby pixels. In single tree mode, the neighbor pixels are stored separately when predicting the entire data. While decoding intra frames normally, the neighbors are sourced from various locations depending on the Luma block's position. However, in CIIP mode, the neighbors remain the same regardless of the processed block. The difference lies in the fact that, during CIIP block processing, the neighbors should always come from a specific location. This separate storage requirement ensures the availability of the correct neighbor pixels for different blocks.

Given these considerations, it becomes essential to store both the Luma and Ch/Cr neighbor pixels separately in CIIP mode. These pixels need to be stored at the start of the block and kept until the entire block is processed. Therefore, separate storage is allocated for the Luma neighbor pixels, as well as the Cb and Cr neighbor pixels. This storage enables the generation of correct data for blocks beyond the first one. The standard requires different neighbor pixels for CIIP intra-prediction compared to normal intra-prediction. Additionally, since CIIP requires data at the start of the block, separate storage is necessary to avoid data loss and ensure the generation of correct data.

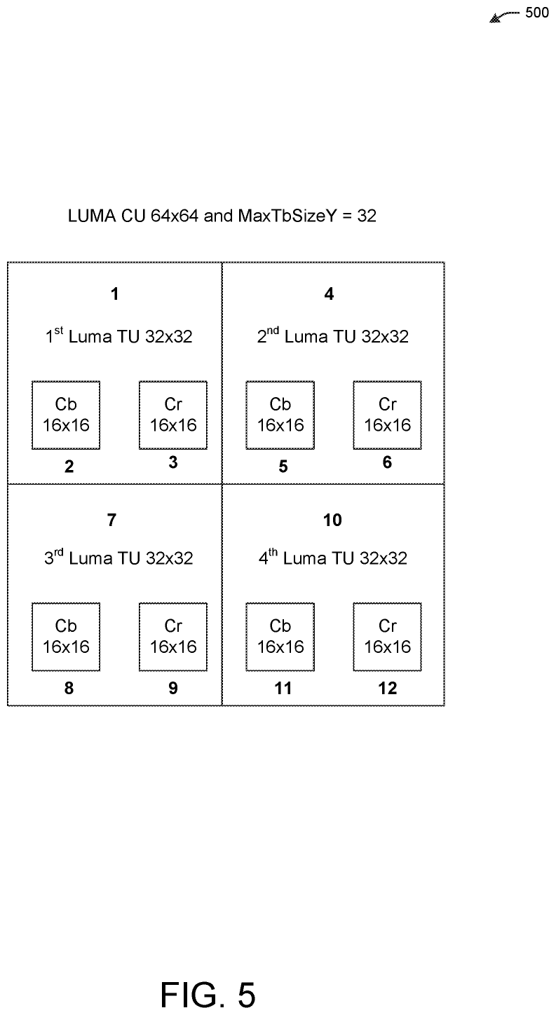

FIG. 5 depicts an illustrative schematic diagram 500 for enhanced video coding, in accordance with one or more example embodiments of the present disclosure.

This disclosure aims to achieve area and power efficiency. One area of focus may be the feature of intra-prediction, where three rows of Luma pixels on top and three columns of Luma pixels on the left side are saved as multi Luma references. The available storage is also reused for storing the current data and neighbor data required for CIIP mode. An enhanced video coding system optimizes the utilization of storage resources by sharing them among different features, thereby enhancing the system's area efficiency.

In sub block partition (SBP) mode, when coding block size is 64×64 and maxTbSize Y is 32 then it gets recursive split and form four 32×32 transform unit blocks with luma and chroma interleaved. In this case, decoding order is 32×32 luma TU followed by two corresponding chroma TUs within coding block unit.

Neighbor recon pixels get updated at every TU component while processing Intra only coded blocks. In CIIP mode, neighbor recon pixels required to be updated at coding block level instead of transform block level to predict Intra data for CIIP coded block. For example, 64×64 coding block with max TbSize Y equals to 32 will have decoding order of 1 to 12 as shown in FIG. 5.

When the 2nd, 3rd, and 4th 32×32 regions in FIG. 5 are decoded, an enhanced video coding system may use the same recon neighbor pixels that are used for the first 32×32 region in order to generate correct Intra predicted pixels. The Top and left neighbor recon pixels get updated at the start of every TU component with respect to current TU start positions. When a pipe reaches the second 32×32 region, some of the neighbor pixels might get updated with the first 32×32 region recon data. To handle this scenario, the design needs to store all luma and chroma recon neighbor pixels at the start of the coding block and reuse them while switching between components as well as subsequent 32×32 regions.

Max storage needed for neighbor recon pixels at the start of the coding block for 4:2:0:
Luma: 131 top+128 left recon pixels.
Cb: 67 top+64 left recon pixels.
Cr: 67 top+64 left recon pixels.

This requires storage of about 30-35K gates. intra-prediction engine has recon neighbor storage for three top rows and three left columns of 128 pixels each to support multi luma reference (MRL) feature. This feature is off when coding block is CIIP coded. This MRL storage is reused to store all the luma and chroma neighbor recon pixels needed in CIIP mode and some extra control logic to reuse this data while switching between components to predict Intra data.

In one or more embodiments, an enhanced video coding system may facilitate enhancements position dependent intra-prediction combinations (PDPC) mode.

VVC performs PDPC for the PLANAR, DC or ANGULAR predicted samples. This step can be viewed as 2nd pass and is done after regular intra-prediction data is calculated. PDPC is applied to smooth the boundary between intra-prediction samples and neighbor recon pixels. PDPC is only enabled for certain transform block sizes and intra-prediction modes.

PDPC is a technique used in advanced video coding, particularly in the VVC standard. The PDPC technique provides an adaptive way of combining the intra-predictions to achieve better coding efficiency. In block-based video encoding, a common method to compress data is by predicting a block's content based on already-encoded nearby blocks (known as intra-prediction). PDPC takes intra-prediction a step further by considering the position of each pixel within the block and weighting the influence of the neighboring pixels accordingly. In effect, the prediction of each pixel depends not only on its neighbors but also on its position relative to them. This can result in more accurate predictions, and thus more efficient encoding.

As mentioned above, after generating the intra-prediction data, an additional step is performed to filter out the predicted pixels. This specific operation is new in VVC and is not present in previous versions. Adding this operation to the hardware pipeline is important, but it also introduces challenges in terms of area and processing time. Adding new logic impacts performance and compromises efficiency. Additionally, extra filtering paths are required after the entire intra-prediction data generation process. To optimize this feature and minimize its impact, it is divided into multiple sections and pre-processed while generating the intra-prediction data. This allows for efficient processing of the PDPC filtering algorithm. Once the intra-prediction data generation is complete, minimal cycles are used to process the PDPC filtering step. This approach optimizes the overall performance of the system.

The PDPC filtering process depends on the nScale parameter, which is derived from the intra-prediction parameters obtained from the bitstream. The nScale parameter is used alongside the main reference x and y parameters. The main reference x represents the top Luma neighbors, which are the neighbor pixels discussed earlier, while the main reference y represents the left neighbors. Additionally, the process requires weight offset for the left and right, as well as the offset for the top reference data. This reference data corresponds to the prediction data generated for the intra-prediction block. In total, four parameters are needed: nScale, main reference x, main reference y, along with the left weight (wL), top weight (wT), and the current prediction data. Once these parameters are derived, the final prediction samples are calculated using the provided equation specified in the standard. In other words, the PDPC process requires derivation of nScale, top and left samples weights (wT and wL) and preparation of left and top reference pixels arrays refL and refT from reference neighbor recon samples and intra-prediction samples. The derivation of these parameters is described below.

### nSacle Derivation

```
  If (predModeIntra > 50)
    nScale = Min (2, Log2(nTbH ) − Floor( Log2( 3 *
    invAngle − 2 ) ) + 8 )
  If (predModeIntra < 18 & predModeIntra! =0 & predModeIntra! = 1 )
    nScale = Min (2, Log2(nTbW ) − Floor( Log2( 3 *
    invAngle − 2 ) ) + 8 )
  else nScale = (Log2( nTbW ) + Log2( nTbH ) − 2 ) >> 2
    nTbW: Max(4, TU Width), nTbH: TU Height
mainRef[ x ] and sideRef[ y ] derivation:
```

Prepare the main and side reference arrays derived from top and left recon neighbor pixels without top left corner pixel.

mainRef[x]=Ptop[x+1] with x=0 . . . refW−1

sideRef[y]=Pleft[y+1] with y=0 . . . refH−1

TABLE 1

| Mode | refW | refH |
|---|---|---|
| ISP | max(TU width, 4) + CU | TU height + CU height |
| | width | |
| Rest Intra | TU width + TU width | TU height + TU height |
| modes | | |

The variables refL[x][y], refT[x][y], wT[y], and wL[x] with x=0 . . . nTbW−1, y=0 . . . nTbH−1 are derived as shown in Table 2.

TABLE 2

| | | Weight | | |
|---|---|---|---|---|
| predModeIntra | Weight wL[x] | wT[y] | refL[x][y] | refT[x][y] |
| Planar (0), | 32 >> ( ( x << 1 ) >> | 32 >> ( ( y << | p[ −1 ][ y ] | p[ x ][ −1 ] |
| DC (1) | nScale ) | 1 ) >> nScale | | |
| | | ) | | |
| HOR (18) | VER(50) ? 32 >> ( ( x | HOR(18)? 32 | p[ −1 ][ y ] − p[ −1 ][ | p[ x ][ −1 ] − p[ −1 |
| VER (50) | << 1 ) >> nScale ) : 0 | >> ( ( y << 1 ) | −1 ] + predSamples[ x | ][ −1 ] + |
| | | >> nScale ) : | ][ y ] | predSamples[ x ][ |
| | | 0 | | y ] |
| < 18 & !=0 & | 0 | 32 >> ( ( y << | 0 | ( y < ( 3 << nScale |
| !=1 & nScale | | 1 ) >> nScale | | ) ) ? mainRef[ dX[ |
| >= 0 | | ) | | x ][ y ] ]:0 |
| | | (0 if | | (0 if nScale<0) |
| | | nScale<0) | | |
| > 50 & <= 80 | 32 >> ( ( x << 1 ) >> | 0 | (x < ( 3 << nScale ) ) ? | 0 |
| && | nScale ) | | sideRef[ dY[ x ][ y ] ]:0 | |
| nScale >= 0 | (0 if nScale<0) | | (0 if nScale<0) | |
| else | 0 | 0 | 0 | 0 |

dY[x][y] in above table with x=0 . . . nTbW−1, y=0 . . . nTbH−1 is calculated as below.

If predModeIntra is less than 18 and not INTRA_PLANAR or INTRA_DC mode and nScale>=0.

```
  dXInt[y] = ((y+1)*invAngle + 256)>>9
  dX[x][y] = x + dXInt[y]
  If predModeIntra is > 50 and less than <=80 and nScale >=0
    dYInt[x] = ((x+1)*invAngle + 256)>>9
    dY[x][y] = y + dXInt[x]
  Final prediction samples are calculated as below for PDPC process,
  predSamples[ x ][ y ] = Clip1( ( refL[ x ][ y ] * wL[ x ] +
  refT[ x ][ y ] * wT[ y ] + ( 64 − wL[ x ] − wT[ y ] ) *
  predSamples[ x ][ y ] + 32 ) >> 6
).
```

Final prediction samples for PDPC process require mathematical computation. Reference arrays refL and refT and weights wL and wT in the above equation need to be computed in parallel with regular intra-prediction samples to meet the overall decoder performance metrics. This entire process is computed in two cycles when PDPC is enabled for INTRA_PLANAR mode. For INTRA_DC and allowed INTRA_ANGULAR modes, this entire process is computed in three cycles without adding any extra cycles of latency after regular intra-prediction is computed. This parallel computing helps achieve comparable performance for Intra frames with respect to previous generations of codecs.

In one or more embodiments, an enhanced video coding system may facilitate inter and CIIP prediction luma mapping and chroma residual scaling (LMCS).

In one or more embodiments, an enhanced video coding system may implement a feature known as LMCS that is recognized within the VVC standard. The system processes two types of data: prediction data, which could be either intra-prediction or inter-prediction data, and residual data. These two types of data are combined to generate a reconstructed pixel, which is the decoded pixel. Specifically, the reconstructed pixel is derived from the sum of prediction data and residual data.

In one or more embodiments, an enhanced video coding system may necessitate post-processing of the prediction data prior to the calculation of the reconstructed pixels, given the condition that the LMCS mapping is activated within the encoded bitstream. The system focuses initially on inter-prediction data luma mapping. Subsequently, the enhanced video coding system considers chroma residual scaling, resulting in the implementation of two distinctive features related to LMCS.

In one or more embodiments, an enhanced video coding system may adjust the inter-prediction data based on two potential modes: combined inter/intra prediction (CIIP) enabled, or CIIP disabled with the block still identified as inter. For instance, when the LMCS mapping is active, the handling of the inter-prediction data varies depending on the status of the CIIP mode (enabled or disabled).

In one or more embodiments, an enhanced video coding system may modify the inter-prediction data using a specific equation when CIIP is disabled. The following equation leverages the LMCS parameters, specifically the LmcsPivot and ScaleCoeff values. For instance, if the system is operating with CIIP disabled, it might adjust the inter-prediction data according to these LMCS parameters to optimize the quality of the reconstructed pixel. The understanding and implementation of these processes underpin the effective functioning of the enhanced video coding system within the framework of the VVC standard.

If ‘sh_lmcs_used_flag’ is equal to 1, luma inter-prediction data for CIIP and non CIIP mode is mapped for LMCS mapping as below.

$$OrgCW = ( 1 << BitDepth ) / 16$$

TABLE 3

| BitDepth | 8 | 9 | 10 |
|---|---|---|---|
| OrgCW | 16 | 32 | 64 |

The variable InputPivot[i], with i=0 . . . 15, is derived as follows:

$$InputPivot [ i ] = i * OrgCW$$

Case 1: CIIP is OFF (disabled)

$$idxY = predSamples [ i ] [ j ] >> Log 2 ( OrgCW )$$

$$predMapSamples [ i ] [ j ] = LmcsPivot [ idxY ] + ( ( ScaleCoeff [ idxY ] * ( ( [ + ( ( ScaleCoeff [ idxY ] * ( predSamples [ i ] [ j ] - InputPivot [ idxY ] ) + ( 1 << 10 ) ) >> 11 )$$

$$with i = 0 … nTbW - 1 , j = 0 .. nTbH - 1$$

Case 2: CIIP is ON (enabled)

When sh_lmcs_used_flag is equal to 1, predSamplesInter[x][y] with x=0 . . . cbWidth−1 and y=0 . . . cbHeight−1 for luma blocks are mapped as follows:

$$idxY = predSamplesInter [ x ] [ y ] >> Log 2 ( OrgCW )$$

$$predSamplesInter [ x ] [ y ] = Clip 1 ( LmcsPivot [ idxY ] + ( ( ScaleCoeff [ idxY ] * ( predSamplesInter [ x ] [ y ] - InputPivot [ idxY ] ) + ( 1 << 10 ) ) >> 11 ) ) .$$

Both CIIP and non CIIP mode luma mapping for inter-prediction logic is shared between both CIIP and non CIIP modes and placed along with recon samples computation design block to simplify validation against the VVC C-model implementation. Reuse and placement of this logic helped reduce significant amount of validation efforts.

Chroma residuals are scaled using luma recon pixels when chroma scaling using LMCS is on. The scaling process for chroma residuals is described in the steps below.

If tuCbfchroma is equal to 1 or cu_act_enabled_flag is equal to 1, residual and recon samples of the current TU are calculated as below with i=0 . . . nTbW−1, j=0 . . . nTbH−1

resSamples[i][j]=Clip3(−(1<<BitDepth), (1<<BitDepth)−1, resSamples[i][j])

recSamples[i][j]=Clip1(predSamples[i][j]+Sign(resSamples[i][j])*((Abs(resSamples[i][j])*varScale+(1<<10))>>11))

The variable varScale in the above equation is derived from average luma recon samples of sizeY and some LMCS parameters as follows where sizeY=Min (CtbSizeY, 64). Luma recon samples are already available in Intra recon neighbor storage and hence varScale is calculated ahead of time while processing luma CU/TU to gain performance advantage for this feature.

for( i = lmcs_min_bin_idx; i <= LmcsMaxBinIdx; i++ ) {
if( invAvgluma < LmcsPivot[ i + 1 ] )
break
}
idxYInv = Min( i, 15 )
varScale = chromaScaleCoeff[ idxYInv ]

In one or more embodiments, an enhanced video coding system may leverage specific LMCS parameters that are typically employed in inter-prediction luma mapping. These parameters are reused to calculate inverse luma average values, which are instrumental in the computation of chroma residual scaling. To illustrate, the system might use a parameter such as LmcsPivot from the inter-prediction luma mapping in the computation of the inverse luma average, thereby contributing to the chroma residual scaling calculation.

In one or more embodiments, an enhanced video coding system may position the chroma scaling logic before the reconstruction computation logic within the processing pipeline. This positioning is intentionally designed to align the system's functionality more closely with the VVC C-model implementation, simplifying validation. Consider the workflow in a practical scenario: after processing inter-prediction luma mapping, the system proceeds to chroma scaling. Following this, the system moves to reconstruction computation, maintaining a flow that mimics the VVC C-model structure.

In one or more embodiments, an enhanced video coding system may result in substantial efficiency gains through this reuse and placement of LMCS-related logic. Such strategic use of the LMCS parameters and careful organization of computational processes can significantly lessen the validation efforts required. For instance, by reusing the same LMCS parameters in multiple calculations and structuring the processing pipeline in alignment with established models, the system reduces the necessity for extensive validation, thereby improving overall operational efficiency.

It is understood that the above descriptions are for the purposes of illustration and are not meant to be limiting.

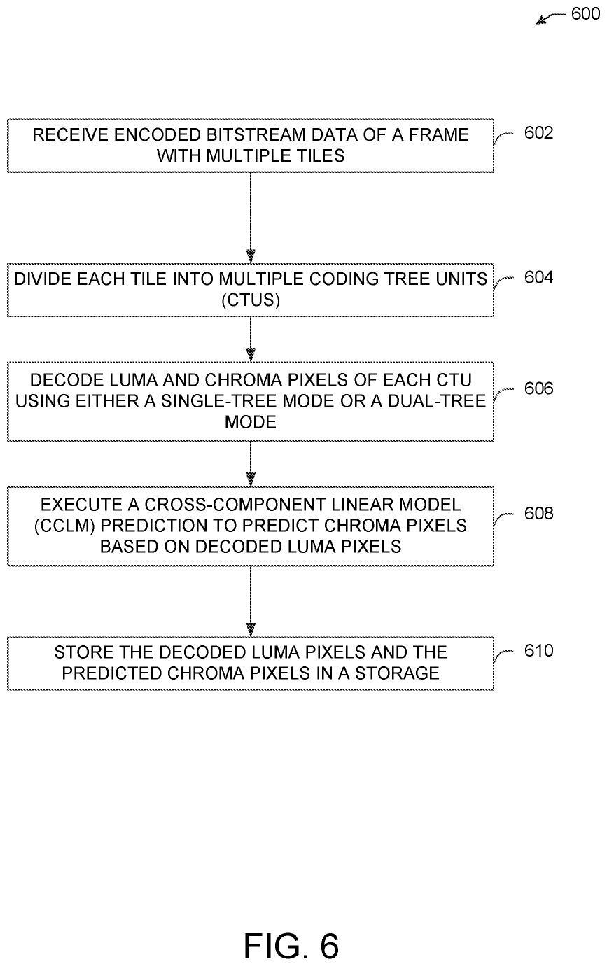

FIG. 6 illustrates a flow diagram of a process 600 for an enhanced video coding system, in accordance with one or more example embodiments of the present disclosure.

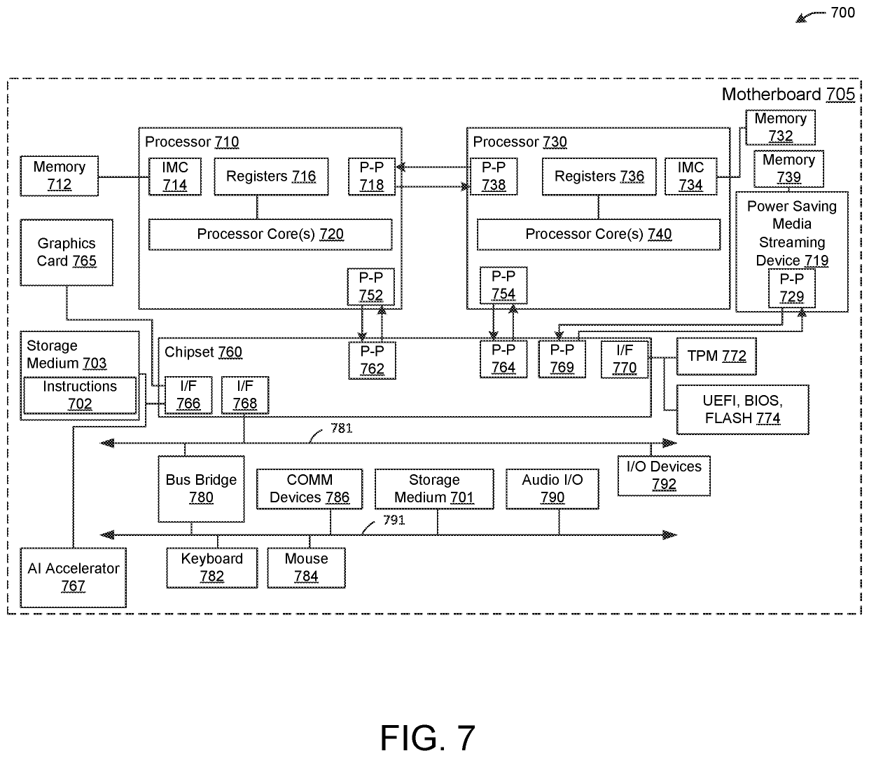

At block 602, a device (e.g., the enhanced video coding device of FIG. 1 and/or the enhanced video coding device 719 of FIG. 7) may receive encoded bitstream data of a frame with multiple tiles.

At block 604, the device may divide each tile into multiple coding tree units (CTUs).

At block 606, the device may decode Luma and Chroma pixels of each CTU using either a single-tree mode or a dual-tree mode.

At block 608, the device may execute a cross-component linear model (CCLM) prediction to predict Chroma pixels based on decoded Luma pixels.

At block 610, the device may store the decoded Luma pixels and the predicted Chroma pixels in a storage.

The device may include capabilities to decode Luma pixels for a given prediction block before decoding the Chroma pixels for the same block within a CTU when operating in the single-tree mode. The device may also contain instructions that allow it to decode all Luma pixels for all prediction blocks inside a CTU before decoding their respective Chroma pixels when operating in dual-tree mode.

In addition to these functions, the device may have the ability to down-sample a Luma block, which includes Luma pixels, using either a 5-tap filter or a 6-tap filter. The device may be equipped to derive Luma neighbor reconstruction parameters from Luma data as well. Once these parameters are derived, the device may use them in combination with a down-sampled Luma block for CCLM prediction.

Furthermore, the device may utilize the Luma neighbor reconstruction parameters in conjunction with down-sampling Luma reconstruction pixels during the CCLM prediction process. In terms of storage, the device may be designed to store a 32×32 set of down-sampled Luma reconstruction pixels, obtained from a 64×64 set of Luma reconstruction pixels, in a separate storage area.

Lastly, the device may include capabilities to receive second encoded bitstream data which incorporates both luma mapping and chroma scaling (LMCS) parameters and prediction data. These combined functionalities allow the device to efficiently process and decode video data for display.

It is understood that the above descriptions are for the purposes of illustration and are not meant to be limiting.

FIG. 7 illustrates an embodiment of an exemplary system 700, in accordance with one or more example embodiments of the present disclosure.

In various embodiments, the computing system 700 may comprise or be implemented as part of an electronic device.

In some embodiments, the computing system 700 may be representative, for example, of a computer system that implements one or more components of FIG. 1.

The embodiments are not limited in this context. More generally, the computing system 700 is configured to implement all logic, systems, processes, logic flows, methods, equations, apparatuses, and functionality described herein and with reference to FIGS. 1-6.

The system 700 may be a computer system with multiple processor cores such as a distributed computing system, supercomputer, high-performance computing system, computing cluster, mainframe computer, mini-computer, client-server system, personal computer (PC), workstation, server, portable computer, laptop computer, tablet computer, a handheld device such as a personal digital assistant (PDA), or other devices for processing, displaying, or transmitting information. Similar embodiments may comprise, e.g., entertainment devices such as a portable music player or a portable video player, a smart phone or other cellular phones, a telephone, a digital video camera, a digital still camera, an external storage device, or the like. Further embodiments implement larger scale server configurations. In other embodiments, the system 700 may have a single processor with one core or more than one processor. Note that the term “processor” refers to a processor with a single core or a processor package with multiple processor cores.

In at least one embodiment, the computing system 700 is representative of one or more components of FIG. 1. More generally, the computing system 700 is configured to implement all logic, systems, processes, logic flows, methods, apparatuses, and functionality described herein with reference to the above figures.

As used in this application, the terms “system” and “component” and “module” are intended to refer to a computer-related entity, either hardware, a combination of hardware and software, software, or software in execution, examples of which are provided by the exemplary system 700. For example, a component can be, but is not limited to being, a process running on a processor, a processor, a hard disk drive, multiple storage drives (of optical and/or magnetic storage medium), an object, an executable, a thread of execution, a program, and/or a computer.

By way of illustration, both an application running on a server and the server can be a component. One or more components can reside within a process and/or thread of execution, and a component can be localized on one computer and/or distributed between two or more computers. Further, components may be communicatively coupled to each other by various types of communications media to coordinate operations. The coordination may involve the uni-directional or bi-directional exchange of information. For instance, the components may communicate information in the form of signals communicated over the communications media. The information can be implemented as signals allocated to various signal lines. In such allocations, each message is a signal. Further embodiments, however, may alternatively employ data messages. Such data messages may be sent across various connections. Exemplary connections include parallel interfaces, serial interfaces, and bus interfaces.

As shown in this figure, system 700 comprises a motherboard 705 for mounting platform components. The motherboard 705 is a point-to-point interconnect platform that includes a processor 710, a processor 730 coupled via a point-to-point interconnects as an Ultra Path Interconnect (UPI), and an enhanced video coding device 719. In other embodiments, the system 700 may be of another bus architecture, such as a multi-drop bus. Furthermore, each of processors 710 and 730 may be processor packages with multiple processor cores. As an example, processors 710 and 730 are shown to include processor core(s) 720 and 740, respectively. While the system 700 is an example of a two-socket (2S) platform, other embodiments may include more than two sockets or one socket. For example, some embodiments may include a four-socket (4S) platform or an eight-socket (8S) platform. Each socket is a mount for a processor and may have a socket identifier. Note that the term platform refers to the motherboard with certain components mounted such as the processors 710 and the chipset 760. Some platforms may include additional components and some platforms may only include sockets to mount the processors and/or the chipset.

The processors 710 and 730 can be any of various commercially available processors. including without limitation an Intel® Celeron®, Core®, Core (2) Duo®, Itanium®, Pentium®, Xeon®, and XScale® processors; AMD® Athlon®, Duron® and Opteron® processors; ARM® application, embedded and secure processors; IBM® and Motorola® DragonBall® and PowerPC® processors; IBM and Sony® Cell processors; and similar processors. Dual microprocessors, multi-core processors, and other multi-processor architectures may also be employed as the processors 710, and 730.

The processor 710 includes an integrated memory controller (IMC) 714, registers 716, and point-to-point (P-P) interfaces 718 and 752. Similarly, the processor 730 includes an IMC 734, registers 736, and P-P interfaces 738 and 754. The IMC's 714 and 734 couple the processors 710 and 730, respectively, to respective memories, a memory 712 and a memory 732. The memories 712 and 732 may be portions of the main memory (e.g., a dynamic random-access memory (DRAM)) for the platform such as double data rate type 3 (DDR3) or type 4 (DDR4) synchronous DRAM (SDRAM). In the present embodiment, the memories 712 and 732 locally attach to the respective processors 710 and 730.

In addition to the processors 710 and 730, the system 700 may include an enhanced video coding device 719. The enhanced video coding device 719 may be connected to chipset 760 by means of P-P interfaces 729 and 769. The enhanced video coding device 719 may also be connected to a memory 739. In some embodiments, the enhanced video coding device 719 may be connected to at least one of the processors 710 and 730. In other embodiments, the memories 712, 732, and 739 may couple with the processor 710 and 730, and the enhanced video coding device 719 via a bus and shared memory hub.

System 700 includes chipset 760 coupled to processors 710 and 730. Furthermore, chipset 760 can be coupled to storage medium 703, for example, via an interface (I/F) 766. The I/F 766 may be, for example, a Peripheral Component Interconnect-enhanced (PCI-e). The processors 710, 730, and the enhanced video coding device 719 may access the storage medium 703 through chipset 760.

Storage medium 703 may comprise any non-transitory computer-readable storage medium or machine-readable storage medium, such as an optical, magnetic or semiconductor storage medium. In various embodiments, storage medium 703 may comprise an article of manufacture. In some embodiments, storage medium 703 may store computer-executable instructions, such as computer-executable instructions 702 to implement one or more of processes or operations described herein, (e.g., process 600 of FIG. 6). The storage medium 703 may store computer-executable instructions for any equations depicted above. The storage medium 703 may further store computer-executable instructions for models and/or networks described herein, such as a neural network or the like. Examples of a computer-readable storage medium or machine-readable storage medium may include any tangible media capable of storing electronic data, including volatile memory or non-volatile memory, removable or non-removable memory, crasable or non-erasable memory, writeable or re-writeable memory, and so forth. Examples of computer-executable instructions may include any suitable types of code, such as source code, compiled code, interpreted code, executable code, static code, dynamic code, object-oriented code, visual code, and the like. It should be understood that the embodiments are not limited in this context.

The processor 710 couples to a chipset 760 via P-P interfaces 752 and 762 and the processor 730 couples to a chipset 760 via P-P interfaces 754 and 764. Direct Media Interfaces (DMIs) may couple the P-P interfaces 752 and 762 and the P-P interfaces 754 and 764, respectively. The DMI may be a high-speed interconnect that facilitates, e.g., eight Giga Transfers per second (GT/s) such as DMI 3.0. In other embodiments, the processors 710 and 730 may interconnect via a bus.

The chipset 760 may comprise a controller hub such as a platform controller hub (PCH). The chipset 760 may include a system clock to perform clocking functions and include interfaces for an I/O bus such as a universal serial bus (USB), peripheral component interconnects (PCIs), serial peripheral interconnects (SPIs), integrated interconnects (I2Cs), and the like, to facilitate connection of peripheral devices on the platform. In other embodiments, the chipset 760 may comprise more than one controller hub such as a chipset with a memory controller hub, a graphics controller hub, and an input/output (I/O) controller hub.

In the present embodiment, the chipset 760 couples with a trusted platform module (TPM) 772 and the UEFI, BIOS, Flash component 774 via an interface (I/F) 770. The TPM 772 is a dedicated microcontroller designed to secure hardware by integrating cryptographic keys into devices. The UEFI, BIOS, Flash component 774 may provide pre-boot code.

Furthermore, chipset 760 includes the I/F 766 to couple chipset 760 with a high-performance graphics engine, graphics card 765. In other embodiments, the system 700 may include a flexible display interface (FDI) between the processors 710 and 730 and the chipset 760. The FDI interconnects a graphics processor core in a processor with the chipset 760.

Various I/O devices 792 couple to the bus 781, along with a bus bridge 780 which couples the bus 781 to a second bus 791 and an I/F 768 that connects the bus 781 with the chipset 760. In one embodiment, the second bus 791 may be a low pin count (LPC) bus. Various devices may couple to the second bus 791 including, for example, a keyboard 782, a mouse 784, communication devices 786, a storage medium 701, and an audio I/O 790.

The artificial intelligence (AI) accelerator 767 may be circuitry arranged to perform computations related to AI. The AI accelerator 767 may be connected to storage medium 703 and chipset 760. The AI accelerator 767 may deliver the processing power and energy efficiency needed to enable abundant-data computing. The AI accelerator 767 is a class of specialized hardware accelerators or computer systems designed to accelerate artificial intelligence and machine learning applications, including artificial neural networks and machine vision. The AI accelerator 767 may be applicable to algorithms for robotics, internet of things, other data-intensive and/or sensor-driven tasks.

Many of the I/O devices 792, communication devices 786, and the storage medium 701 may reside on the motherboard 705 while the keyboard 782 and the mouse 784 may be add-on peripherals. In other embodiments, some or all the I/O devices 792, communication devices 786, and the storage medium 701 are add-on peripherals and do not reside on the motherboard 705.

Some examples may be described using the expression “in one example” or “an example” along with their derivatives. These terms mean that a particular feature, structure, or characteristic described in connection with the example is included in at least one example. The appearances of the phrase “in one example” in various places in the specification are not necessarily all referring to the same example.

Some examples may be described using the expression “coupled” and “connected” along with their derivatives. These terms are not necessarily intended as synonyms for each other. For example, descriptions using the terms “connected” and/or “coupled” may indicate that two or more elements are in direct physical or electrical contact with each other. The term “coupled,” however, may also mean that two or more elements are not in direct contact with each other, yet still co-operate or interact with each other.

In addition, in the foregoing Detailed Description, various features are grouped together in a single example to streamline the disclosure. This method of disclosure is not to be interpreted as reflecting an intention that the claimed examples require more features than are expressly recited in each claim. Rather, as the following claims reflect, the inventive subject matter lies in less than all features of a single disclosed example. Thus, the following claims are hereby incorporated into the Detailed Description, with each claim standing on its own as a separate example. In the appended claims, the terms “including” and “in which” are used as the plain-English equivalents of the respective terms “comprising” and “wherein,” respectively. Moreover, the terms “first,” “second,” “third,” and so forth, are used merely as labels and are not intended to impose numerical requirements on their objects.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code to reduce the number of times code must be retrieved from bulk storage during execution. The term “code” covers a broad range of software components and constructs, including applications, drivers, processes, routines, methods, modules, firmware, microcode, and subprograms. Thus, the term “code” may be used to refer to any collection of instructions which, when executed by a processing system, perform a desired operation or operations.

Logic circuitry, devices, and interfaces herein described may perform functions implemented in hardware and implemented with code executed on one or more processors. Logic circuitry refers to the hardware or the hardware and code that implements one or more logical functions. Circuitry is hardware and may refer to one or more circuits. Each circuit may perform a particular function. A circuit of the circuitry may comprise discrete electrical components interconnected with one or more conductors, an integrated circuit, a chip package, a chipset, memory, or the like. Integrated circuits include circuits created on a substrate such as a silicon wafer and may comprise components. And integrated circuits, processor packages, chip packages, and chipsets may comprise one or more processors.

Processors may receive signals such as instructions and/or data at the input(s) and process the signals to generate the at least one output. While executing code, the code changes the physical states and characteristics of transistors that make up a processor pipeline. The physical states of the transistors translate into logical bits of ones and zeros stored in registers within the processor. The processor can transfer the physical states of the transistors into registers and transfer the physical states of the transistors to another storage medium.

A processor may comprise circuits to perform one or more sub-functions implemented to perform the overall function of the processor. One example of a processor is a state machine or an application-specific integrated circuit (ASIC) that includes at least one input and at least one output. A state machine may manipulate the at least one input to generate the at least one output by performing a predetermined series of serial and/or parallel manipulations or transformations on the at least one input.

The logic as described above may be part of the design for an integrated circuit chip. The chip design is created in a graphical computer programming language, and stored in a computer storage medium or data storage medium (such as a disk, tape, physical hard drive, or virtual hard drive such as in a storage access network). If the designer does not fabricate chips or the photolithographic masks used to fabricate chips, the designer transmits the resulting design by physical means (e.g., by providing a copy of the storage medium storing the design) or electronically (e.g., through the Internet) to such entities, directly or indirectly. The stored design is then converted into the appropriate format (e.g., GDSII) for the fabrication.

The resulting integrated circuit chips can be distributed by the fabricator in raw wafer form (that is, as a single wafer that has multiple unpackaged chips), as a bare die, or in a packaged form. In the latter case, the chip is mounted in a single chip package (such as a plastic carrier, with leads that are affixed to a motherboard or other higher-level carrier) or in a multichip package (such as a ceramic carrier that has either or both surface interconnections or buried interconnections). In any case, the chip is then integrated with other chips, discrete circuit elements, and/or other signal processing devices as part of either (a) an intermediate product, such as a processor board, a server platform, or a motherboard, or (b) an end product.

The word “exemplary” is used herein to mean “serving as an example, instance, or illustration.” Any embodiment described herein as “exemplary” is not necessarily to be construed as preferred or advantageous over other embodiments. The terms “computing device,” “user device,” “communication station,” “station,” “handheld device,” “mobile device,” “wireless device” and “user equipment” (UE) as used herein refers to a wireless communication device such as a cellular telephone, a smartphone, a tablet, a netbook, a wireless terminal, a laptop computer, a femtocell, a high data rate (HDR) subscriber station, an access point, a printer, a point of sale device, an access terminal, or other personal communication system (PCS) device. The device may be either mobile or stationary.

As used within this document, the term “communicate” is intended to include transmitting, or receiving, or both transmitting and receiving. This may be particularly useful in claims when describing the organization of data that is being transmitted by one device and received by another, but only the functionality of one of those devices is required to infringe the claim. Similarly, the bidirectional exchange of data between two devices (both devices transmit and receive during the exchange) may be described as “communicating,” when only the functionality of one of those devices is being claimed. The term “communicating” as used herein with respect to a wireless communication signal includes transmitting the wireless communication signal and/or receiving the wireless communication signal. For example, a wireless communication unit, which is capable of communicating a wireless communication signal, may include a wireless transmitter to transmit the wireless communication signal to at least one other wireless communication unit, and/or a wireless communication receiver to receive the wireless communication signal from at least one other wireless communication unit.

As used herein, unless otherwise specified, the use of the ordinal adjectives “first,” “second,” “third,” etc., to describe a common object, merely indicates that different instances of like objects are being referred to and are not intended to imply that the objects so described must be in a given sequence, either temporally, spatially, in ranking, or in any other manner.

The following examples pertain to further embodiments.

Example 1 may include a system that comprises at least one memory that stores computer-executable instructions; and at least one processor configured to access the at least one memory and execute the computer-executable instructions to: receive encoded bitstream data of a frame with multiple tiles; divide each tile into multiple coding tree units (CTUs); decode Luma and Chroma pixels of each CTU using either a single-tree mode or a dual-tree mode; execute a cross-component linear model (CCLM) prediction to predict Chroma pixels based on decoded Luma pixels; and store the decoded Luma pixels and the predicted Chroma pixels in a storage.

Example 2 may include the system of example 1 and/or some other example herein, further comprising computer-executable instructions to decode, in the single-tree mode, the Luma pixels for a given prediction block prior to decoding the Chroma pixels for the same block within a CTU.

Example 3 may include the system of example 1 and/or some other example herein, further comprising computer-executable instructions to decode, in the dual-tree mode, all Luma pixels for all prediction blocks inside a CTU prior to the decoding of the respective Chroma pixels.

Example 4 may include the system of example 1 and/or some other example herein, further comprising computer-executable instructions to down-sample a Luma block comprising the Luma pixels using either a 5-tap filter or a 6-tap filter,

Example 5 may include the system of example 1 and/or some other example herein, further comprising computer-executable instructions to derive Luma neighbor reconstruction parameters from Luma data.

Example 6 may include the system of example 5 and/or some other example herein. further comprising computer-executable instructions to use the Luma neighbor reconstruction parameters with down-sampled Luma block for the CCLM prediction.

Example 7 may include the system of example 6 and/or some other example herein. wherein the CCLM prediction utilizes the Luma neighbor reconstruction parameters in conjunction with down-sampling Luma reconstruction pixels.

Example 8 may include the system of example 1 and/or some other example herein, further comprising computer-executable instructions to store a 32×32 set of down sampled Luma reconstruction pixels from 64×64 set of Luma reconstruction pixels in a separate storage.

Example 9 may include the system of example 1 and/or some other example herein, further comprising computer-executable instructions to receive second encoded bitstream data incorporating luma mapping and chroma scaling (LMCS) parameters and prediction data.

Example 10 may include a non-transitory computer-readable medium storing computer-executable instructions which when executed by one or more processors result in performing operations comprising: receiving encoded bitstream data of a frame with multiple tiles; dividing each tile into multiple coding tree units (CTUs); decoding Luma and Chroma pixels of each CTU using either a single-tree mode or a dual-tree mode; executing a cross-component linear model (CCLM) prediction to predict Chroma pixels based on decoded Luma pixels; and storing the decoded Luma pixels and the predicted Chroma pixels in a storage.

Example 11 may include the non-transitory computer-readable medium of example 10 and/or some other example herein, wherein the operations further comprise decoding, in the single-tree mode, the Luma pixels for a given prediction block prior to decoding the Chroma pixels for the same block within a CTU.

Example 12 may include the non-transitory computer-readable medium of example 10 and/or some other example herein, wherein the operations further comprise decoding, in the dual-tree mode, all Luma pixels for all prediction blocks inside a CTU prior to the decoding of the respective Chroma pixels.

Example 13 may include the non-transitory computer-readable medium of example 10 and/or some other example herein, wherein the operations further comprise down-sampling a Luma block comprising the Luma pixels using either a 5-tap filter or a 6-tap filter,

Example 14 may include the non-transitory computer-readable medium of example 10 and/or some other example herein, wherein the operations further comprise deriving Luma neighbor reconstruction parameters from Luma data.

Example 15 may include the non-transitory computer-readable medium of example 14 and/or some other example herein, wherein the operations further comprise using the Luma neighbor reconstruction parameters with down-sampled Luma block for the CCLM prediction.

Example 16 may include the non-transitory computer-readable medium of example 15 and/or some other example herein, wherein the CCLM prediction utilizes the Luma neighbor reconstruction parameters in conjunction with down-sampling Luma reconstruction pixels.

Example 17 may include the non-transitory computer-readable medium of example 10 and/or some other example herein, wherein the operations further comprise storing a 32×32 set of down sampled Luma reconstruction pixels from 64×64 set of Luma reconstruction pixels in a separate storage.

Example 18 may include the non-transitory computer-readable medium of example 10 and/or some other example herein, wherein the operations further comprise receiving second encoded bitstream data incorporating luma mapping and chroma scaling (LMCS) parameters and prediction data.

Example 19 may include a method comprising: receiving, by one or more processors, encoded bitstream data of a frame with multiple tiles; dividing each tile into multiple coding tree units (CTUs); decoding Luma and Chroma pixels of each CTU using either a single-tree mode or a dual-tree mode; executing a cross-component linear model (CCLM) prediction to predict Chroma pixels based on decoded Luma pixels; and storing the decoded Luma pixels and the predicted Chroma pixels in a storage.

Example 20 may include the method of example 19 and/or some other example herein, further comprising decoding, in the single-tree mode, the Luma pixels for a given prediction block prior to decoding the Chroma pixels for the same block within a CTU.

Example 21 may include the method of example 19 and/or some other example herein, further comprising decoding, in the dual-tree mode, all Luma pixels for all prediction blocks inside a CTU prior to the decoding of the respective Chroma pixels.

Example 22 may include the method of example 19 and/or some other example herein, further comprising down-sampling a Luma block comprising the Luma pixels using either a 5-tap filter or a 6-tap filter,

Example 23 may include the method of example 19 and/or some other example herein, further comprising deriving Luma neighbor reconstruction parameters from Luma data.

Example 24 may include the method of example 23 and/or some other example herein. further comprising using the Luma neighbor reconstruction parameters with down-sampled Luma block for the CCLM prediction.

Example 25 may include the method of example 24 and/or some other example herein, wherein the CCLM prediction utilizes the Luma neighbor reconstruction parameters in conjunction with down-sampling Luma reconstruction pixels.

Example 26 may include the method of example 19 and/or some other example herein. further comprising storing a 32×32 set of down sampled Luma reconstruction pixels from 64×64 set of Luma reconstruction pixels in a separate storage.

Example 27 may include the method of example 19 and/or some other example herein. further comprising receiving second encoded bitstream data incorporating luma mapping and chroma scaling (LMCS) parameters and prediction data.

Example 28 may include an apparatus comprising means for: receiving encoded bitstream data of a frame with multiple tiles; dividing each tile into multiple coding tree units (CTUs); decoding Luma and Chroma pixels of each CTU using either a single-tree mode or a dual-tree mode; executing a cross-component linear model (CCLM) prediction to predict Chroma pixels based on decoded Luma pixels; and storing the decoded Luma pixels and the predicted Chroma pixels in a storage.

Example 29 may include the apparatus of example 28 and/or some other example herein, further comprising decoding, in the single-tree mode, the Luma pixels for a given prediction block prior to decoding the Chroma pixels for the same block within a CTU.

Example 30 may include the apparatus of example 28 and/or some other example herein, further comprising decoding, in the dual-tree mode, all Luma pixels for all prediction blocks inside a CTU prior to the decoding of the respective Chroma pixels.

Example 31 may include the apparatus of example 28 and/or some other example herein, further comprising down-sampling a Luma block comprising the Luma pixels using either a 5-tap filter or a 6-tap filter,

Example 32 may include the apparatus of example 28 and/or some other example herein, further comprising deriving Luma neighbor reconstruction parameters from Luma data.

Example 33 may include the apparatus of example 32 and/or some other example herein, further comprising using the Luma neighbor reconstruction parameters with down-sampled Luma block for the CCLM prediction.

Example 34 may include the apparatus of example 33 and/or some other example herein, wherein the CCLM prediction utilizes the Luma neighbor reconstruction parameters in conjunction with down-sampling Luma reconstruction pixels.

Example 35 may include the apparatus of example 28 and/or some other example herein, further comprising storing a 32×32 set of down sampled Luma reconstruction pixels from 64×64 set of Luma reconstruction pixels in a separate storage.

Example 36 may include the apparatus of example 28 and/or some other example herein, further comprising receiving second encoded bitstream data incorporating luma mapping and chroma scaling (LMCS) parameters and prediction data.

Example 37 may include one or more non-transitory computer-readable media comprising instructions to cause an electronic device, upon execution of the instructions by one or more processors of the electronic device, to perform one or more elements of a method described in or related to any of examples 1-36, or any other method or process described herein.

Example 38 may include an apparatus comprising logic, modules, and/or circuitry to perform one or more elements of a method described in or related to any of examples 1-36, or any other method or process described herein.

Example 39 may include a method, technique, or process as described in or related to any of examples 1-36, or portions or parts thereof.

Example 40 may include an apparatus comprising: one or more processors and one or more computer readable media comprising instructions that, when executed by the one or more processors, cause the one or more processors to perform the method, techniques, or process as described in or related to any of examples 1-36, or portions thereof.

Embodiments according to the disclosure are in particular disclosed in the attached claims directed to a method, a storage medium, a device and a computer program product, wherein any feature mentioned in one claim category, e.g., method, can be claimed in another claim category, e.g., system, as well. The dependencies or references back in the attached claims are chosen for formal reasons only. However, any subject matter resulting from a deliberate reference back to any previous claims (in particular multiple dependencies) can be claimed as well, so that any combination of claims and the features thereof are disclosed and can be claimed regardless of the dependencies chosen in the attached claims. The subject-matter which can be claimed comprises not only the combinations of features as set out in the attached claims but also any other combination of features in the claims, wherein each feature mentioned in the claims can be combined with any other feature or combination of other features in the claims. Furthermore, any of the embodiments and features described or depicted herein can be claimed in a separate claim and/or in any combination with any embodiment or feature described or depicted herein or with any of the features of the attached claims.

The foregoing description of one or more implementations provides illustration and description but is not intended to be exhaustive or to limit the scope of embodiments to the precise form disclosed. Modifications and variations are possible in light of the above teachings or may be acquired from practice of various embodiments.

Certain aspects of the disclosure are described above with reference to block and flow diagrams of systems, methods, apparatuses, and/or computer program products according to various implementations. It will be understood that one or more blocks of the block diagrams and flow diagrams, and combinations of blocks in the block diagrams and the flow diagrams, respectively, may be implemented by computer-executable program instructions. Likewise, some blocks of the block diagrams and flow diagrams may not necessarily need to be performed in the order presented, or may not necessarily need to be performed at all, according to some implementations.

These computer-executable program instructions may be loaded onto a special-purpose computer or other particular machine, a processor, or other programmable data processing apparatus to produce a particular machine, such that the instructions that execute on the computer, processor, or other programmable data processing apparatus create means for implementing one or more functions specified in the flow diagram block or blocks. These computer program instructions may also be stored in a computer-readable storage media or memory that may direct a computer or other programmable data processing apparatus to function in a particular manner, such that the instructions stored in the computer-readable storage media produce an article of manufacture including instruction means that implement one or more functions specified in the flow diagram block or blocks. As an example, certain implementations may provide for a computer program product, comprising a computer-readable storage medium having a computer-readable program code or program instructions implemented therein, said computer-readable program code adapted to be executed to implement one or more functions specified in the flow diagram block or blocks. The computer program instructions may also be loaded onto a computer or other programmable data processing apparatus to cause a series of operational elements or steps to be performed on the computer or other programmable apparatus to produce a computer-implemented process such that the instructions that execute on the computer or other programmable apparatus provide elements or steps for implementing the functions specified in the flow diagram block or blocks.

Accordingly, blocks of the block diagrams and flow diagrams support combinations of means for performing the specified functions, combinations of elements or steps for performing the specified functions and program instruction means for performing the specified functions. It will also be understood that each block of the block diagrams and flow diagrams, and combinations of blocks in the block diagrams and flow diagrams, may be implemented by special-purpose, hardware-based computer systems that perform the specified functions, elements or steps, or combinations of special-purpose hardware and computer instructions.

Conditional language, such as, among others, ““can,”” ““could,”” ““might,”” or ““may,”” unless specifically stated otherwise, or otherwise understood within the context as used, is generally intended to convey that certain implementations could include, while other implementations do not include, certain features, elements, and/or operations. Thus, such conditional language is not generally intended to imply that features, elements, and/or operations are in any way required for one or more implementations or that one or more implementations necessarily include logic for deciding, with or without user input or prompting, whether these features, elements, and/or operations are included or are to be performed in any particular implementation.

Many modifications and other implementations of the disclosure set forth herein will be apparent having the benefit of the teachings presented in the foregoing descriptions and the associated drawings. Therefore, it is to be understood that the disclosure is not to be limited to the specific implementations disclosed and that modifications and other implementations are intended to be included within the scope of the appended claims. Although specific terms are employed herein, they are used in a generic and descriptive sense only and not for purposes of limitation.

What is claimed is:

1. A system, comprising: at least one memory that stores computer-executable instructions; and at least one processor configured to access the at least one memory and execute the computer-executable instructions to:
receive encoded bitstream data of a frame with multiple tiles;
divide each tile into multiple coding tree units (CTUs);
decode Luma and Chroma pixels of each CTU using either a single-tree mode or a dual-tree mode;
execute a cross-component linear model (CCLM) prediction to predict Chroma pixels based on decoded Luma pixels; and
store the decoded Luma pixels and the predicted Chroma pixels in a storage.

2. The system of claim 1, further comprising computer-executable instructions to decode, in the single-tree mode, the Luma pixels for a given prediction block prior to decoding the Chroma pixels for the same block within a CTU.

3. The system of claim 1, further comprising computer-executable instructions to decode, in the dual-tree mode, all Luma pixels for all prediction blocks inside a CTU prior to the decoding of the respective Chroma pixels.

4. The system of claim 1, further comprising computer-executable instructions to down-sample a Luma block comprising the Luma pixels using either a 5-tap filter or a 6-tap filter,

5. The system of claim 1, further comprising computer-executable instructions to derive Luma neighbor reconstruction parameters from Luma data.

6. The system of claim 5, further comprising computer-executable instructions to use the Luma neighbor reconstruction parameters with down-sampled Luma block for the CCLM prediction.

7. The system of claim 6, wherein the CCLM prediction utilizes the Luma neighbor reconstruction parameters in conjunction with down-sampling Luma reconstruction pixels.

8. The system of claim 1, further comprising computer-executable instructions to store a 32×32 set of down sampled Luma reconstruction pixels from 64×64 set of Luma reconstruction pixels in a separate storage.

9. The system of claim 1, further comprising computer-executable instructions to receive second encoded bitstream data incorporating luma mapping and chroma scaling (LMCS) parameters and prediction data.

10. A non-transitory computer-readable medium storing computer-executable instructions which when executed by one or more processors result in performing operations comprising:
receiving encoded bitstream data of a frame with multiple tiles;
dividing each tile into multiple coding tree units (CTUs);
decoding Luma and Chroma pixels of each CTU using either a single-tree mode or a dual-tree mode;
executing a cross-component linear model (CCLM) prediction to predict Chroma pixels based on decoded Luma pixels; and
storing the decoded Luma pixels and the predicted Chroma pixels in a storage.

11. The non-transitory computer-readable medium of claim 10, wherein the operations further comprise decoding, in the single-tree mode, the Luma pixels for a given prediction block prior to decoding the Chroma pixels for the same block within a CTU.

12. The non-transitory computer-readable medium of claim 10, wherein the operations further comprise decoding, in the dual-tree mode, all Luma pixels for all prediction blocks inside a CTU prior to the decoding of the respective Chroma pixels.

13. The non-transitory computer-readable medium of claim 10, wherein the operations further comprise down-sampling a Luma block comprising the Luma pixels using either a 5-tap filter or a 6-tap filter,

14. The non-transitory computer-readable medium of claim 10, wherein the operations further comprise deriving Luma neighbor reconstruction parameters from Luma data.

15. The non-transitory computer-readable medium of claim 14, wherein the operations further comprise using the Luma neighbor reconstruction parameters with down-sampled Luma block for the CCLM prediction.

16. The non-transitory computer-readable medium of claim 15, wherein the CCLM prediction utilizes the Luma neighbor reconstruction parameters in conjunction with down-sampling Luma reconstruction pixels.

17. The non-transitory computer-readable medium of claim 10, wherein the operations further comprise storing a 32×32 set of down sampled Luma reconstruction pixels from 64×64 set of Luma reconstruction pixels in a separate storage.

18. The non-transitory computer-readable medium of claim 10, wherein the operations further comprise receiving second encoded bitstream data incorporating luma mapping and chroma scaling (LMCS) parameters and prediction data.

19. A method comprising:
receiving, by one or more processors, encoded bitstream data of a frame with multiple tiles;
dividing each tile into multiple coding tree units (CTUs);
decoding Luma and Chroma pixels of each CTU using either a single-tree mode or a dual-tree mode;
executing a cross-component linear model (CCLM) prediction to predict Chroma pixels based on decoded Luma pixels; and
storing the decoded Luma pixels and the predicted Chroma pixels in a storage.

20. The method of claim 19. further comprising decoding, in the single-tree mode, the Luma pixels for a given prediction block prior to decoding the Chroma pixels for the same block within a CTU.
